(19) United States
(12) Patent Application Publication
(10) Pub. No.: US 2026/0205635 A1
(43) Pub. Date: Jul. 16, 2026

(54) ADAPTIVE COMPRESSION FOR REMOTE IMAGE DATA POST-PROCESSING

(71) Applicant: KONINKLIJKE PHILIPS N.V., EINDHOVEN (NL)

(72) Inventors: Renatus Josephus VAN DER VLEUTEN, VELDHOVEN (NL); Frank BERGNER, HAMBURG (DE); Michael GRASS, BUCHHOLZ IN DER NORDHEIDE (DE)

(21) Appl. No.: 19/138,173

(22) PCT Filed: Dec. 11, 2023
(86) PCT No.: PCT/EP2023/085069

§ 371 Date: Jun. 12, 2025

Related U.S. Application Data
(60) Provisional application No. 63/432,480, filed on Dec. 14, 2022.

(51) Int. Cl. H04N 19/86; H04N 19/172; H04N 19/37

(52) U.S. Cl. CPC H04N 19/86; H04N 19/172; H04N 19/37

(57) ABSTRACT

A method includes receiving from a client computing device (“CCD)” a request to perform a given post-processing type on compressed image data, receiving from the CCD a first amount of compressed image data, obtaining an image from the first amount of compressed image data, post-processing the image obtained from the first amount of compressed image data with a post-processing algorithm, in response to a result of the post-processing failing to satisfy a predetermined requirement, iteratively, and until the result of the post-processing satisfies the predetermined requirement: requesting a greater amount of compressed image data from the CCD, receiving the greater amount of compressed image data from the CCD, obtaining an image using the greater amount of compressed image data, and post-processing the image obtained using the greater amount of compressed image data with the post-processing algorithm, and returning to the CCD the result of the post-processing satisfying the predetermined requirement.

### TECHNICAL FIELD

The following generally relates to image processing and more particularly to adaptive compression for remote image data post-processing.

### BACKGROUND

With cloud-based image data post-processing, a client sends image data to the cloud, processing resources of the cloud process the image data with post-processing algorithms (e.g., segmentation, etc.), and cloud services return results of the post-processing to the client. However, medical image data sets (e.g., computed tomography, magnetic resonance, etc.) can be large, and transmission bandwidth is not unlimited. As a consequence, the time it takes to transfer the image data and receive the post-processing results can lead to a negative impact on the user experience, at least due to latency with receiving the results. The literature indicates that transmission time can exceed post processing (e.g., segmentation) time.

Data compression can be used to reduce a size or amount of an image data set. However, the amount of image data sent for post-processing can impact the quality of the post-processing results. For example, the quality of post-processing results may not satisfy a quality metric if not enough image data is sent for post-processing, e.g., the depth of the compression is too great. In another example, more image data may be sent than necessary to satisfy the quality metric, unnecessarily increasing transmission time. As such, there is an unresolved need for an improved approach(s) with remote, e.g., cloud-based, image data post-processing.

### SUMMARY

Aspects described herein address the above-referenced problems and/or others.

In one aspect, a computer-implemented method includes receiving from a client computing device a request to perform a given post-processing type on compressed image data, receiving from the client computing device a first amount of compressed image data, obtaining an image from the first amount of compressed image data, post-processing the image obtained from the first amount of compressed image data with a post-processing algorithm, in response to a result of the post-processing failing to satisfy a predetermined requirement, iteratively, and until the result of the post-processing satisfies the predetermined requirement: requesting a greater amount of compressed image data from the client computing device, receiving the greater amount of compressed image data from the client computing device, obtaining an image using the greater amount of compressed image data, and post-processing the image obtained using the greater amount of compressed image data with the post-processing algorithm, and returning, to the client computing device, the result of the post-processing in response to the result of the post-processing satisfying the predetermined requirement.

In another aspect, a remote resource(s), a set of post-processing algorithms, and a result checker, wherein the remote resource(s) is configured to receive, from a client computing device, a request to perform a given post-processing type on a first amount of compressed image data, the remote resource(s) is configured to obtain an image from the first amount of compressed image data, the remote resource(s) is further configured to post-process the image from the first amount of compressed image data with a post-processing algorithm, the result checker is configured to check a result of the post-processing against a predetermined requirement, and wherein the remote resource(s) is further configured to, in response to a result of the post-processing failing to satisfy the predetermined requirement, iteratively, and until the result of the post-processing satisfies the predetermined requirement: request a greater amount of image data from the client computing device, receive the greater amount of the image data from the client computing device, obtain an image using the greater amount of image data, and post-process the image obtained using the greater amount of image data with the post-processing algorithm, and wherein the remote resource(s) is further configured to return, to the client computing device, the result of the post-processing in response to the result of the post-processing satisfying the predetermined requirement.

In another aspect, a computer readable medium is encoded with computer executable instructions that cause a processor to receive, from a client computing device, a request to perform a given post-processing type on a first amount of compressed image data, obtain an image from the first amount of compressed image data, post-process the image obtained from the first amount of compressed image data with a post-processing algorithm, check a result of the post-processing against a predetermined requirement, in response to a result of the post-processing failing to satisfy the predetermined requirement, iteratively, and until the result of the post-processing satisfies the predetermined requirement: request a greater amount of image data from the client computing device, receive the greater amount of the image data from the client computing device, obtain an image using the greater amount of image data, and post-process the image obtained using the greater amount of image data with the post-processing algorithm, and return, to the client computing device, the result of the post-processing in response to the result of the post-processing satisfying the predetermined requirement.

Those skilled in the art will recognize still other aspects of the present application upon reading and understanding the attached description.

### BRIEF DESCRIPTION OF THE DRAWINGS

The invention may take form in various components and arrangements of components, and in various steps and arrangements of steps. The drawings are only for purposes of illustrating the embodiments and are not to be construed as limiting the invention.

FIG. 1 diagrammatically illustrates an example, in accordance with an embodiment(s) herein.

FIG. 2 diagrammatically illustrates a variation of the example system of system FIG. 1, in accordance with an embodiment(s) herein.

FIG. 3 illustrates an example of a post-processing algorithm to compression algorithm mapping, in accordance with an embodiment(s) herein.

FIG. 4 illustrates an example method, in accordance with an embodiment(s) herein.

FIG. 5 illustrates another example method, in accordance with an embodiment(s) herein.

FIG. 6 illustrates yet another example method, in accordance with an embodiment(s) herein.

### DESCRIPTION OF EMBODIMENTS

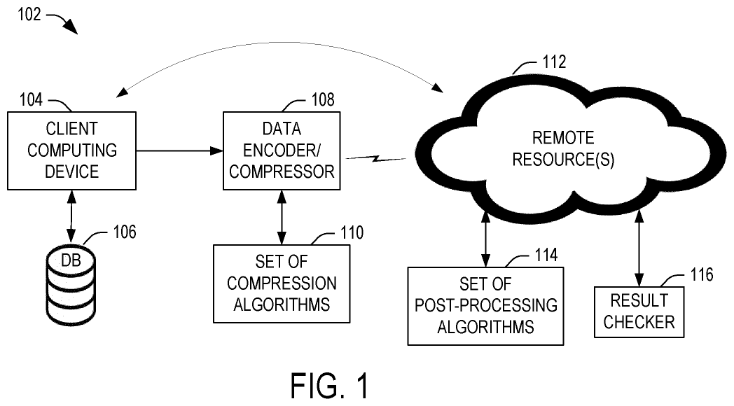

FIG. 1 diagrammatically illustrates an example system 102. The system 102 includes a client computing device 104. The client computing device 104 includes a processor and computer readable medium. Non-limiting examples of suitable processors include a central processing unit (CPU), a microprocessor (uP), and/or other processor. The computer readable medium includes non-transitory storage medium such as physical memory, a memory device, etc., and excludes transitory medium. The client computing device 104 can be part of a medical imaging system, a picture archiving and communication system (PACS) such as Philips® Intellispace® PACS, an image management system such IntellispaceR Cardiovascular, an advanced visualization system for radiologists such as Philips® Intellispace® Portal, a teleradiology system, a viewing workstation and/or other medical devices and systems with specialized hardware and/or software for processing medically diagnostic information.

The client computing device 104 is operatively coupled to a database (DB) 106. In one instance, the DB 106 is part of the client computing device 104. In another instance, the DB 106 remote from the client computing device 104 and communication therebetween is through a wire and/or wireless network. In such an instance, the DB 106 can be part of cloud storage resources, a server, a workstation, a medical imaging system/scanner, a Radiology Information System (RIS), Hospital Information System (HIS), an electronic medical record (EMR), a PACS, etc.

The DB 106 at least stores image data, including image data of and/or from the client computing device 104 and/or another device(s). In one instance, the image data is stored based on the Digital Imaging and Communications in Medicine (DICOM) standard for the communication and management of medical imaging information and related data. The image data may include raw data and/or processed data, e.g., individual images, volumetric (three-dimensional) image data, etc. The DB 106 may comprise one or more storage devices.

The system 102 further includes a data encoder/compressor 108. The data encoder/compressor 108 is operatively coupled to the client computing device 104. The data encoder/compressor 108 is configured to compress data such as the image data in the DB 106 to provide image data with fewer bits than the original, non-compressed image data. The data encoder/compressor 108 employs one or more compression algorithms of a set of compression algorithms 110, including lossless and/or lossy compression algorithms, hierarchical or scalable compression algorithms such as, e.g., JPEG 2000, JPEG, JPEG-XL, JPEG-2000, High-throughput JPEG2000 (HTJ2K), Philips iSyntax, etc.

With such an algorithm, the code-stream organization is hierarchical or scalable by pixel accuracy and/or by image resolution. As such, a fewer bit lower quality version of the image data can initially be generated, and, if desired, the quality of the image data can be progressively increased through more data bits from layers of the hierarchical organization, e.g., where each iteration provides more bits of data and increases the quality. Alternatively, the image data can be reprocessed to produce a higher quality (more bits) version relative to the initial fewer bit lower quality version.

In one instance, the data encoder/compressor 108 is part of the client computing device 104. In another instance, the data encoder/compressor 108 is part of another computing device. In another instance, the data encoder/compressor 108 is part of a cloud-based data encoder/compressor. The set of compression algorithms 110 can include off-the-shelf compression algorithms, trained compression algorithms, or off-the-shelf and trained compression algorithms.

A remote resource(s) 112 includes computing services such as storage, processing, analytics, intelligence, etc. An example of the remote resource 112 includes cloud-based computing services, or computing services provided to computing devices over the Internet, on-demand. The remote resource(s) 112 includes a set of post-processing algorithms 114. Such algorithms include segmentation (e.g., organ), detection (e.g., structure), registration (e.g., pre vs post treatment), classification (e.g., benign or malignant), diagnosis (e.g., cancer), outcome prediction, etc., including artificial intelligence/machine learning based algorithms such as trained neural networks, etc.

The remote resource(s) 112 further includes a result checker 116. The result checker 116 is configured to determine whether the output of a post-processing algorithm of the set of post-processing algorithms 114 has achieved a predetermined quality and/or reliability. For example, if a post-processing algorithm is based on machine-learning, the post-processing algorithm is trained to also provide a confidence/quality output, e.g., an uncertainty of the result via a probability, a confidence interval, etc. Alternatively, or additionally, the algorithm could, e.g., perform certain checks/metrics on the post-processing input and/or output.

An example of a result check for a segmentation service includes utilizing known shapes and/or boundaries. For instance, the normal shape of a heart is generally known, although it can vary from subject to subject. The training can include training with image data of a normal heart. Statistical information such as a mean, etc. can be determined from the image data. If the shape of the heart from a heart segmentation post-processing algorithm is outside of the distribution, the result check may indicate that more image data is needed to provide a segmentation of the heart that satisfies the quality and/or reliability requirement. Other features for the heart include local curvature, gray scale value changes, surrounding tissue or lack thereof, etc. A shape outside of the distribution may alternatively indicate a tumor or lesion.

In one embodiment, the client computing device 104 sends a request to the remote resource(s) 112 for a post-processing service (e.g., segment certain tissue). The client computing device 104 also instructs the data encoder/compressor 108 to compress image data with the compression algorithm (and level for a hierarchical algorithm) of the set of compression algorithms 110 that provides a greatest or near greatest compression, or returns a smallest or near smallest sized compressed file. In general, such a compressed file will have a lowest quality and/or reliability relative to other compression algorithms and/or levels of the compression. The client computing device 104 instructs the data encoder/compressor 108 to transmit the compressed image data to the remote resource(s) 112.

The remote resource(s) 112 decodes the compressed image data and processes the decoded image data, e.g., an image(s), with a post-processing algorithm of the set of post-processing algorithms 114. The result checker 116 checks whether the post-processing result satisfies predetermined quality and/or reliability requirement. In response to the result satisfying the predetermined quality and/or reliability requirement, the remote resource(s) 112 returns the result to the client computing device 104, which can visually present the result via a display monitor of a user.

If the result does not satisfy the predetermined quality and/or reliability requirement, the remote resource(s) 112 returns feedback indicating that the present amount of image data does not satisfy the predetermined quality and/or reliability requirement and more quality image data is needed. In one instance, the client computing device 104 responds by having the data encoder/compressor 108 compress the image data with an algorithm that generates higher quality image data and transmits the higher quality image data to the remote resource(s) 112. The remote resource(s) 112 decodes the compressed image data and processes the decoded image data, and the result checker 116 checks the result against the predetermined quality and/or reliability requirement.

Where a hierarchical or scalable compression algorithm was used for the compression, the client computing device 104 responds by transmitting additional image data. The remote resource(s) 112 combines the additional image data with the previously received image data and processes the combined image data, and the result checker 116 the result against the predetermined quality and/or reliability requirement. The remote resource(s) 112 and the client computing device 104 iteratively communicate as such until the post-processing result satisfies predetermined quality and/or reliability requirement. In one instance, this results in sending as little image data as possible to the remote resource(s) 112.

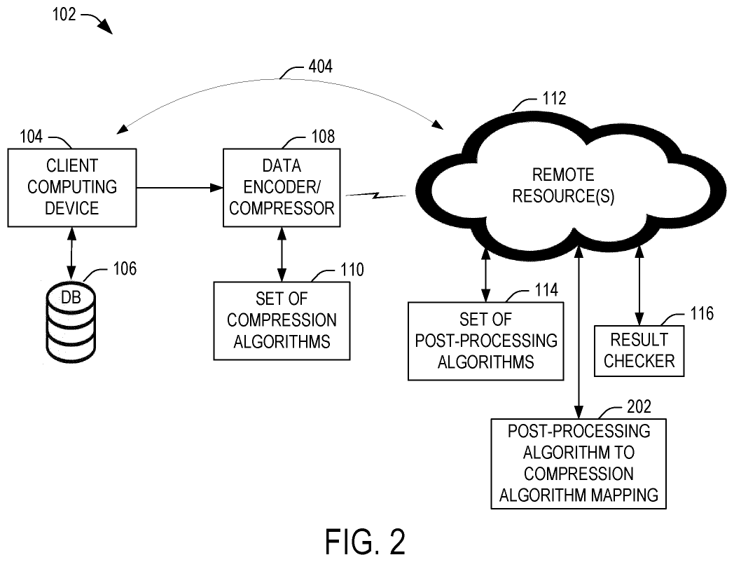

FIG. 2 diagrammatically illustrates a variation of the example system 102. In this variation, the system 102 further includes a post-processing algorithm to compression algorithm mapping 202. The post-processing algorithm to compression algorithm mapping 202 includes a mapping to a compression algorithm that provides a greatest or near greatest compression while still satisfying the predetermined quality and/or reliability requirement for a plurality of the post-processing algorithms in the set of post-processing algorithms 114. For the mapping 202, post-processing algorithms are trained with non-compressed image data and compressed image data.

In one instance, the training data includes full (non-compressed) image data sets annotated by clinicians and compressed versions of the full image data with variable quality, e.g., image data sets compressed with the different algorithms from the set of compression algorithms 110 and different levels of compression for hierarchical based compression algorithms. In some instances, the training data further includes image data sets modified to include data of interest (e.g., modifying pixel/voxel values to add a particular diseased tissue to otherwise healthy tissue), perturbations with known compression error, and/or other training data.

In another instance, the post-processing algorithms can be made fault/noise tolerant or robust by different methods, such as algorithm changes or additions. In case of AI based post-processing, the underlying networks can be trained using samples with different levels of noise applied to them. Furthermore, additional noise-dependent normalization steps can be added to support different levels of input noise. By using samples with different levels of applied compression, the post-processing algorithm is also trained to be robust against specific compression artifacts that arise using the chosen compression algorithm.

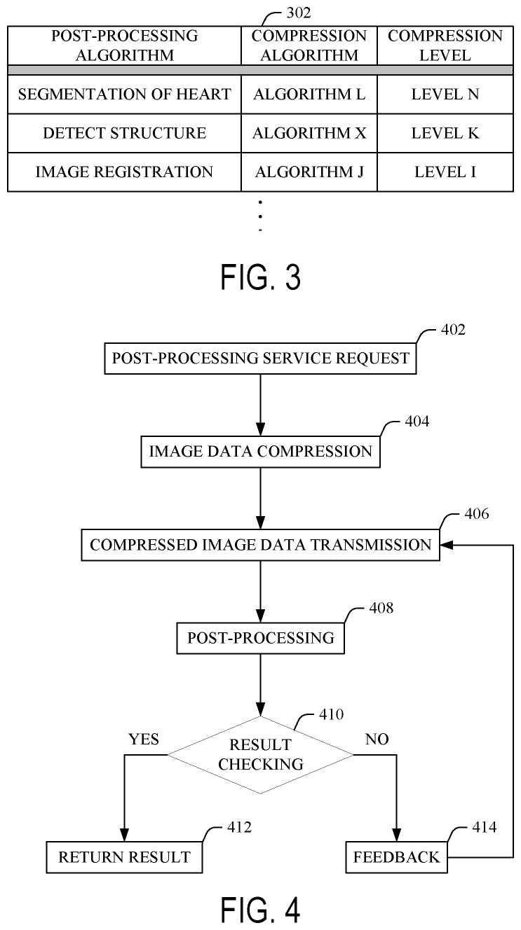

Turning briefly to FIG. 3, an example mapping 302 of the post-processing algorithm to compression algorithm mapping 202 is illustrated. The mapping 302 at least maps a segmentation algorithm for segmenting the heart to a compression algorithm L and a compression level N, a detect structure algorithm to a compression algorithm X and a compression level K, an image registration to a compression algorithm J and a compression level I, . . . . Although the illustrated compression algorithms and levels are different, in some instances the same compression algorithm is the compression algorithm for different services (e.g., where L=X).

Returning to FIG. 2, in one embodiment the client computing device 104 sends a request to the remote resource(s) 112 for a post-processing service (e.g., segment certain tissue). The remote resource(s) 112 identifies a compression algorithm (and level, where available) of the set of post-processing algorithms 114 for the requested service from the post-processing algorithm to compression algorithm mapping 202. For example, a compression algorithm suitable for a segmentation of the head from a body scan may be different from a compression algorithm suitable for a segmentation of small duct vessels. In another example, the compression algorithm is any compression algorithm(s) known to one having ordinary skill the art with a compression rate that would not cause smaller features (e.g., small vessels) in images to become more difficult to see. The remote resource(s) 112 sends a response to the client computing device 104 that indicates the identified compression algorithm (and level).

The client computing device 104 instructs the data encoder/compressor 108 to compress image data with the identified compression algorithm (and level). The data encoder/compressor 108 retrieves the identified compression algorithm (and level) from the set of compression algorithms 110 and compresses the image data with the retrieved compression algorithm (and level). In general, the compressed image data may or may not have a lowest quality and/or reliability relative to other compression algorithms and/or levels of the compression. The client computing device 104 instructs the data encoder/compressor 108 to transmit the compressed image data to the remote resource(s) 112.

The remote resource(s) 112 decodes the compressed image data and processes the decoded image data with a post-processing algorithm of the set of post-processing algorithms 114. The result checker 116 checks whether the post-processing result satisfies predetermined quality and/or reliability requirement. In response to the result satisfying the predetermined quality and/or reliability requirement, the remote resource(s) 112 returns the result to the client computing device 104, which can visually present the result via a display monitor of a user.

If the result does not satisfy the predetermined quality and/or reliability requirement, the remote resource(s) 112 returns feedback indicating that the amount of image data does not satisfy the predetermined quality and/or reliability requirement and additional image data is needed. Even though the remote resource(s) 112 suggested the compressed algorithm employed by the data encoder/compressor 108, the result may not satisfy the predetermined quality and/or reliability requirement, e.g., due to variability of lesions, anatomy, etc. across image data. For instance, the subject image data may include image data outside of a statistical distribution of the training image data set.

The remote resource(s) 112 requests either more image data, e.g., where a hierarchical compression algorithm was utilized, or suggests a different compression algorithm, e.g., a compression algorithm of set of compression algorithms 110 identified in the post-processing algorithm to compression algorithm mapping 202 that was previously determined to provide a next greatest level of compression while still satisfying the predetermined quality and/or reliability requirement. The client computing device 104 responds by sending the additional image data or by having the data encoder/compressor 108 compress the image data with the newly suggested compression algorithm and sends the higher compressed image data.

The remote resource(s) 112 processes the compressed image data with the decoded additional image data or the decoded higher compressed image data, and the result checker 116 checks whether the post-processing result satisfies predetermined quality and/or reliability requirement. The remote resource(s) 112 and the client computing device 104 communicate as such until the post-processing result satisfies predetermined quality and/or reliability requirement. The post-processing algorithm to compression algorithm mapping 202 can be updated to map to the compression algorithm that ended up satisfying the predetermined quality and/or reliability requirement.

In another embodiment, the client computing device 104 sends request to the remote resource(s) 112 for a post-processing service (e.g., segment certain tissue), and the remote resource(s) 112 responds by indicating there is no suggested compression algorithm in the post-processing algorithm to compression algorithm mapping 202 and recommends a predetermined default compression algorithm. In one instance, the client computing device 104 uses the predetermined default compression algorithm.

In another instance, the client computing device 104 uses the compression algorithm that results in a greatest compression, e.g., as discussed in connection with FIG. 1 or other compression. The process then follows the process discussed above in connection with FIG. 1 or FIG. 2, a combination thereof, or another approach. In any instance, the post-processing algorithm to compression algorithm mapping 202 can be updated to include the algorithm (and level, if available) that ended up satisfying the predetermined quality and/or reliability requirement.

Alternatively, or additionally, the result not satisfying the predetermined quality and/or reliability requirement is sent back to the client computing device 104 for display and the quality and/or reliability of the result is successively improved over time, e.g., through the remote resource(s) 112 post-processing additional image data received from the client computing device 104 and transmitting the additional results to the client computing device 104 where the additional results are combined with the previously received result to increase quality and/or reliability.

Optionally, after the client computing device 104 receives a result that satisfies the predetermined result requirement, the client computing device 104 sends higher quality image data and/or the entire non-compressed image data to the remote resource(s) 112, which processes the higher quality and/or non-compressed image data and returns the result, e.g., for archival and/or comparative purposes. Since a result that satisfies the predetermined result requirement has already been received, this can be done at a lower speed and/or in between live user sessions.

In one instance, the remote resource(s) 112 further indicates a desired priority for the image data for the particular post-processing algorithm. For example, in one instance the remote resource(s) 112 indicates a priority of a low resolution image at a higher quality for a post-processing algorithm. In another instance, the remote resource(s) 112 indicates a priority of a higher resolution image at a lower quality for another post-processing algorithm. In another instance, the remote resource(s) 112 indicates a luminance image should be provided first and later followed by color component information for another post-processing algorithm.

In another instance, the remote resource(s) 112 includes an iterative algorithm that optimizes a loss function, e.g., squared error loss, mean squared error loss, etc. In one example of image registration, the loss or quality metric can be in the form of

$$L ( ω ) = \int {( {f}_{0} ( x ) - {f}_{1} ( ω ( x ) ) )}^{2} dx$$

which is a total squared error of registering a volume f₁ onto an initial volume f₀ using a deformation field w (x) over all spatial position x of the volume. The client computing device 104 sends over compressed versions of f₀ and f₁ which are used to iteratively calculate a suitable w on the remote resource(s) 112. Then, client computing device 104 can determine the loss value using the non-compressed version of f₀ and f₁. In this case, the client computing device 104 calculates the loss function a single time using a latest result from the remote resource(s) 112. The resulting value could be used as an indication of the quality of the processing. For instance, a high cost function value would indicate that a cost function minimum or a sufficiently low value has not yet been found and more image data is required.

In another instance, numeric perturbations estimated and modeled as numeric noise can be added to the training data set. An example includes classes of algorithms that involve quantization, where a reduction of used bits typically leads to random errors with known amplitude and random distribution. Such information can be used by the remote resource(s) 112 to generate multiple, additional perturbated samples based on the received data. By processing these set of samples along with the original data, the remote resource(s) 112 can deduct processing errors on a statistical basis. For example, in case of segmentation, the amount of changes in the segmented pixel can be assessed, and, in case of classification, the stability of a prediction of a particular class can be assessed. Additionally, or alternatively, the training data set can include different levels of acquisition subsampling.

In another instance, the compression algorithms and post-processing algorithms are concurrently trained to tune the compression algorithm and the post-processing algorithm to each other, e.g., for compression favorable to achieve good post-processing results with less image data. Once trained, the compression algorithms are loaded in the set of trained compression algorithms 110 and the trained post-processing algorithms are loaded in the set of post-processing algorithms 114. In one instance, information on acquisition parameters, noise level, the reconstruction filter, sampling, etc. is considered when training the compression algorithms. In another instance, such information is not utilized when training the compression algorithms.

In another instance, a compression algorithm may be based on different image aspects that are relevant for the reduction of image data and also influence the final processing results. Examples of such image aspects include, but are not limited to, pixel size and pixel value representation. For pixel size, the remote resource(s) 112 may request the client computing device 104 to only send a coarse image if a fine granularity is not needed for the processing. For pixel value representation, the remote resource(s) 112 may lower the number of bits per pixel value (e.g., 8-bit instead of 16-bit to represent gray value) or map/quantize the values to a reduced set of values.

FIG. 4 discloses a computer-implemented method. It is to be appreciated that the ordering of the acts of the method is not limiting. As such, other orderings are contemplated herein. In addition, one or more acts may be omitted, and/or one or more additional acts may be included.

In a post-processing requesting step 402, the client computing device 104 sends request to the remote resource(s) 112 for a post-processing service, as described herein and/or otherwise. In an image data compression step 404, the client computing device 104 instructs the data encoder/compressor 108 to compress image data with a certain compression algorithm, as described herein and/or otherwise. In a compressed image data transmission step 406, the client computing device 104 instructs the data encoder/compressor 108 to transmit the compressed image data to the remote resource(s) 112, as described herein and/or otherwise.

In a post-processing step 408, the remote resource(s) 112 decodes the compressed image data and processes the decoded image data with a post-processing algorithm, as described herein and/or otherwise. In a result checking step 410, the result checker 116 checks whether the post-processing result satisfies a predetermined quality and/or reliability requirement, as described herein and/or otherwise. If the result satisfies the predetermined quality and/or reliability requirement, then in a return result step 412 the remote resource(s) 112 returns the result to the client computing device 104, which presents the result via a display monitor of a user, as described herein and/or otherwise.

If the result does not satisfy the predetermined quality and/or reliability requirement, then in a feedback step 414 the remote resource(s) 112 returns feedback requesting more image data, as described herein and/or otherwise. Steps 406-410 are repeated until the result satisfies the predetermined result metric and the remote resource(s) 112 returns the result to the client computing device 104.

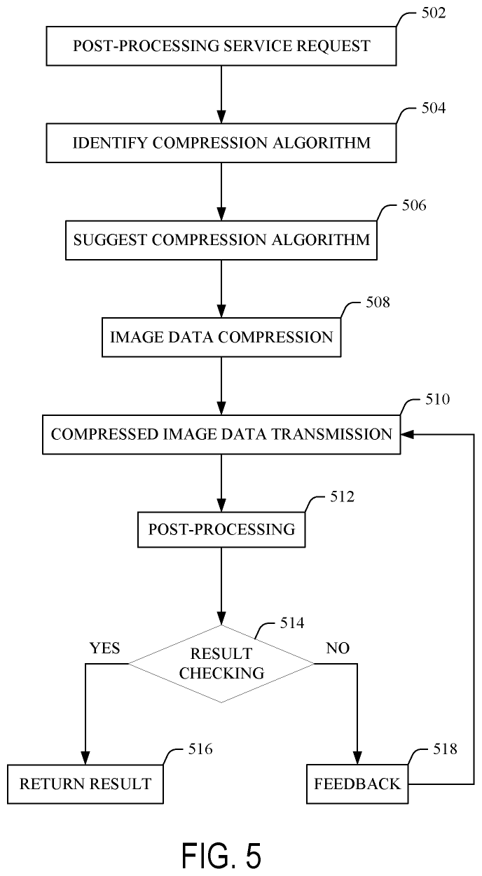

FIG. 5 discloses a computer-implemented method. It is to be appreciated that the ordering of the acts of the method is not limiting. As such, other orderings are contemplated herein. In addition, one or more acts may be omitted, and/or one or more additional acts may be included.

In a post-processing service request step 502, the client computing device 104 sends request to the remote resource(s) 112 for a post-processing service, as described herein and/or otherwise. In a compression algorithm identification step 504, the remote resource(s) 112 identifies a compression algorithm (and level, where the compression algorithm is a hierarchical compression algorithm) for the requested service in the mapping 202, as described herein and/or otherwise. In a suggested compression algorithm step 506, The remote resource(s) 112 sends a response to the client computing device 104 that indicates the identified compression algorithm (and level).

In an image data compression step 508, the client computing device 104 instructs the data encoder/compressor 108 to compress image data with the suggested compression algorithm, as described herein and/or otherwise. In a compressed image data transmission step 510, the client computing device 104 instructs the data encoder/compressor 108 to transmit the compressed image data to the remote resource(s) 112, as described herein and/or otherwise.

In a post-processing step 512, the remote resource(s) 112 decodes the compressed image data and processes the decoded image data with a post-processing algorithm, as described herein and/or otherwise. In a result checking step 514, the result checker 116 checks whether the post-processing result satisfies a predetermined quality and/or reliability requirement, as described herein and/or otherwise. If the result satisfies the predetermined result metric, then in a return result step 516 the remote resource(s) 112 returns the result to the client computing device 104, which presents the result via a display monitor of a user, as described herein and/or otherwise.

If the result does not satisfy the predetermined quality and/or reliability requirement, then in a feedback step 518 the remote resource(s) 112 returns feedback requesting more image data, e.g., another level of compression for a hierarchical compression algorithm or another compressed set of image data, as described herein and/or otherwise. Steps 510-514 are repeated until the result satisfies the predetermined result metric and the remote resource(s) 112 returns the result to the client computing device 104. The mapping 202 can be updated based on the amount of image data required to satisfy the predetermined quality and/or reliability requirement.

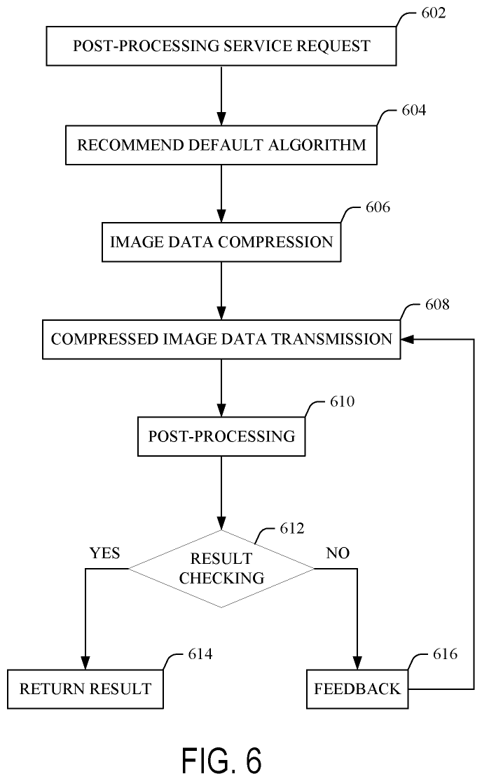

FIG. 6 discloses a computer-implemented method. It is to be appreciated that the ordering of the acts of the method is not limiting. As such, other orderings are contemplated herein. In addition, one or more acts may be omitted, and/or one or more additional acts may be included.

In a post-processing service requesting step 602, the client computing device 104 sends request to the remote resource(s) 112 for a post-processing service, as described herein and/or otherwise. Where the remote resource(s) 112 is unable to identify a compression algorithm, e.g., where there is no mapping from post-processing algorithm to compression algorithm in the mapping 202, in a recommended default algorithm step 604, the remote resource(s) 112 sends a response to the client computing device 104 that recommends a default compression algorithm.

In an image data compression step 606, the client computing device 104 instructs the data encoder/compressor 108 to compress image data with the default or other compression algorithm, e.g., a client identified or selected compression algorithm, as described herein and/or otherwise. In a compressed image data transmission step 608, the client computing device 104 instructs the data encoder/compressor 108 to transmit the compressed image data to the remote resource(s) 112, as described herein and/or otherwise.

In a post-processing step 610, the remote resource(s) 112 decodes the compressed image data and processes the decoded image data with a post-processing algorithm, as described herein and/or otherwise. In a result checking step 612, the results checker 116 checks whether the post-processing result satisfies a predetermined quality and/or reliability requirement, as described herein and/or otherwise. If the result satisfies the predetermined quality and/or reliability requirement, then in a return result step 614 the remote resource(s) 112 returns the result to the client computing device 104, which presents the result via a display monitor of a user, as described herein and/or otherwise.

If the result does not satisfy the predetermined quality and/or reliability requirement, then in a feedback step 616 the remote resource(s) 112 returns feedback requesting more image data, as described herein and/or otherwise. Steps 608-612 are repeated until the result satisfies the predetermined result metric and the remote resource(s) 112 returns the result to the client computing device 104. The mapping 202 can be updated to include a mapping based on the amount of image data required to satisfy the predetermined quality and/or reliability requirement.

The above methods can be implemented by way of computer readable instructions, encoded, or embedded on the computer readable storage medium, which, when executed by a computer processor, cause the processor to carry out the described acts or functions. Additionally, or alternatively, at least one of the computer readable instructions is carried out by a signal, carrier wave or other transitory medium, which is not computer readable storage medium.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

The word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A computer-implemented method, comprising:
receiving, from a client computing device, a request to perform a given post-processing type on compressed image data;
receiving, from the client computing device, a first amount of compressed image data;
obtaining an image from the first amount of compressed image data;
post-processing the image obtained from the first amount of compressed image data with a post-processing algorithm;
in response to a result of the post-processing failing to satisfy a predetermined requirement, iteratively, and until the result of the post-processing satisfies the predetermined requirement:
requesting a greater amount of compressed image data from the client computing device;
receiving the greater amount of compressed image data from the client computing device;
obtaining an image using the greater amount of compressed image data; and
post-processing the image obtained using the greater amount of compressed image data with the post-processing algorithm; and
returning, to the client computing device, the result of the post-processing in response to the result of the post-processing satisfying the predetermined requirement.

2. The computer-implemented method of claim 1, wherein the given post-processing type at least includes one or more of segmentation, classification, detection, diagnosis, outcome prediction, artifact correction, noise reduction, and registration.

3. The computer-implemented method of claim 1, wherein the compressed image data was compressed with a compression algorithm selected by the client computing device from a set of compression algorithms.

4. The computer-implemented method of claim 3, wherein compression algorithms in the set of compression algorithms are configured to provide different amounts of compression, and the selected compression algorithm provides greater amount of compression.

5. The computer-implemented method of claim 1, further comprising:
in response to receiving the request, providing a signal to the client computing device that indicates a suggested compression algorithm, wherein the compressed image data was compressed with the suggested compression algorithm.

6. The computer-implemented method of claim 5, further comprising:
determining the suggested compression algorithm from a predetermined mapping that maps post-processing types to compression algorithm.

7. The computer-implemented method of claim 6, further comprising:
mapping a post-processing type to a compression algorithm that provides a greater compression for a given quality or reliability.

8. The computer-implemented method of claim 5, wherein the compression algorithm is a hierarchical compression algorithm with a plurality of levels of compression, the first amount includes a first level of compression, and the greater amount includes a different level of compression.

9. The computer-implemented method of claim 1, wherein the post-processing algorithm includes a machine learning post-processing algorithm.

10. The computer-implemented method of claim 9, wherein the machine learning post-processing algorithm includes a post-processing algorithm trained with compressed image data of variable quality.

11. The computer-implemented method of claim 9, wherein the machine learning post-processing algorithm includes a post-processing algorithm trained with image data with numeric perturbations estimated and modeled as numeric noise.

12. The computer-implemented method of claim 9, further comprising:
providing an uncertainty of the result to the client computing device with the result.

13. The computer-implemented method of claim 1, where the compression algorithm is based on an image aspect including at least one of pixel size and pixel value.

14. The computer-implemented method of claim 1, where the compression algorithm is based on one or more of an acquisition parameter, a noise level, a reconstruction filter, and a sampling.

15. A system, comprising:
a remote resource(s);
a set of post-processing algorithms; and
a result checker,
wherein the remote resource(s) is configured to receive, from a client computing device, a request to perform a given post-processing type on a first amount of compressed image data,
wherein the remote resource(s) is configured to obtain an image from the first amount of compressed image data;
wherein the remote resource(s) is further configured to post-process the image from the first amount of compressed image data with a post-processing algorithm;
wherein the result checker is configured to check a result of the post-processing against a predetermined requirement,
wherein the remote resource(s) is further configured to, in response to a result of the post-processing failing to satisfy the predetermined requirement, iteratively, and until the result of the post-processing satisfies the predetermined requirement:
request a greater amount of image data from the client computing device;
receive the greater amount of the image data from the client computing device;
obtain an image using the greater amount of image data; and
post-process the image obtained using the greater amount of image data with the post-processing algorithm, and
wherein the remote resource(s) is further configured to return, to the client computing device, the result of the post-processing in response to the result of the post-processing satisfying the predetermined requirement.

16. The system of claim 15, wherein the compression algorithm includes a hierarchical compression algorithm with a plurality of levels of compression, the first amount includes a first level of compression, and the greater amount includes a different level of compression.

17. The system of claim 15, wherein the compression algorithm is a trained compression algorithm.

18. A computer readable medium encoded with computer executable instructions, which, when executed by a processor, causes the processor to:
receive, from a client computing device, a request to perform a given post-processing type on a first amount of compressed image data;
obtain an image from the first amount of compressed image data;
post-process the image obtained from the first amount of compressed image data with a post-processing algorithm;
check a result of the post-processing against a predetermined requirement;
in response to a result of the post-processing failing to satisfy the predetermined requirement, iteratively, and until the result of the post-processing satisfies the predetermined requirement:
request a greater amount of image data from the client computing device;
receive the greater amount of the image data from the client computing device;
obtain an image using the greater amount of image data; and
post-process the image obtained using the greater amount of image data with the post-processing algorithm; and
return, to the client computing device, the result of the post-processing in response to the result of the post-processing satisfying the predetermined requirement.

19. The computer readable medium of claim 18, wherein the compression algorithm includes a hierarchical compression algorithm with a plurality of levels of compression, the first amount includes a first level of compression, and the greater amount includes a different level of compression.

20. The computer readable medium of claim 18, wherein the compression algorithm is a trained compression algorithm.
